(19) United States
(12) Patent Application Publication
(10) Pub. No.: US 2004/0251080 A1
(43) Pub. Date: Dec. 16, 2004

(54) Retractable and extensible step assembly

(76) Inventor: George P. Kalos, Chelmsford, MA (US)

Correspondence Address: Michael L. Leetzow, Esq., Michael L. Leetzow, P.A., 5213 SHORELINE CIRCLE, SANFORD, FL, 32771, US

(21) Appl. No.: 10/462,338

(22) Filed: Jun. 16, 2003

(51) Int. Cl. E06C 1/00

(52) U.S. Cl. 182/35; 182/88

(57) ABSTRACT

An extensible and retractable step assembly is provided that has a base and a first step. The step is attached to one end of the base and rotates up on the base. The step has first and second stepping surfaces for reaching different heights. The step assembly may be inserted before or after the cabinet is installed.

The present invention relates to a retractable and extensible step assembly, and more particularly, to a retractable and extensible step assembly with minimal parts that can be stored under a cabinet without taking storage space from the cabinet.

There are prior art steps including, for example, steps that are stored in a cabinet and complicated steps that are stored under the cabinet with many moving parts. U.S. Pat. No. 3,311,190, for example, is directed to a child aid for lavatories and the like. The invention is a rigid step unit having two steps in a base portion in the form of a drawer. However, the step unit must be pivoted upward and the supporting rails must be moved forward and into abutment with the drawer. This requires the user to bend over and physically move step up and into place. The user must also reverse the process and lower the step before closing the drawer.

U.S. Pat. No. 3,481,429 also discloses a drawer step. The drawer step has a frame and a step, legs hingedly affixed to the step, and a foldable support structure secured to the frame. As with the previous step, this drawer step also requires that the user either bend down or use a foot to pull the step upward into usable position. If the folding legs of the step are not appropriately positioned, the step could collapse, possibly injuring the user.

U.S. Pat. No. 5,005,667 is directed to an extensible and retractable step assembly for a cabinet standing on a floor. The step assembly has an open rectangular base with a step therein. The step must be raised and pulled forward to engage cross pins on the lower ends of linkage arms in downwardly offset notches at the ends of slots in the base. However, if the cross pins come out of the notches through bumping the step or otherwise, the step will collapse, possibly injuring the user.

Similarly, the collapsible and retractable step apparatus in U.S. Pat. No. 5,341,897 may also be prone to instability and requires considerable effort in setting up for use.

Accordingly, the present invention is directed to a retractable and extensible step that substantially obviates one or more of the problems and disadvantages in the prior art. Additional features and advantages of the invention will be set forth in the description that follows, and in part will be apparent from the description, or may be learned by practice of the invention. The objectives and other advantages of the invention will be realized and attained by the apparatus particularly pointed out in the written description and claims, as well as the appended drawings.

### SUMMARY OF THE INVENTION

To achieve these and other advantages and in accordance with the purpose of the invention as embodied and broadly described herein, the invention is directed to a a retractable and extensible step assembly to be disposed within a cabinet on the floor, the step assembly includes a base, a step hingingly connected to a first end of the base, the step having a first stepping surface and a second stepping surface, the first stepping surface being disposed on a first side of the step and the second stepping surface being disposed on a second side of the first step, the first and second sides being opposite one another, and a cabinet engagement means disposed on the base to slidingly engage the cabinet.

In another aspect, the invention provides for a retractable and extensible step assembly to be added to a cabinet after the cabinet has been installed at a location, the step assembly includes a sliding element to attach the step assembly in a hole in the cabinet, a retractable and extensible step assembly, the step assembly including a base, a step hingingly connected to the base, the step having a first stepping surface and a second stepping surface, the first stepping surface being disposed on a first side of the step and the second stepping surface being disposed on a second side of the first step, the first and second sides being opposite one another.

It is to be understood that the foregoing general description and the following detailed description are exemplary and explanatory and are intended to provide further explanation of the invention as claimed.

The accompanying drawings are included to provide a further understanding of the invention and are incorporated in and constitute a part of the specification. The drawings illustrate several embodiments of the invention and together with the description serve to explain the principles of the invention.

### BRIEF DESCRIPTION OF THE DRAWINGS

FIG. 1 is a front perspective view of a floor cabinet and a wall cabinet with one embodiment of a step assembly according to the present invention;

FIG. 2 is a perspective view of the step assembly with the cabinets of FIG. 1 in a second configuration;

FIG. 3 is an enlarged view of the step assembly separated from the cabinets;

FIG. 4 is an enlarged view of the step assembly separated from the cabinets and in the second configuration;

FIG. 5 is a front view of the of the step assembly of FIG. 4;

FIG. 6 is a cross sectional view of the step assembly along the line 6-6 in Fig. FIG. 3;

FIG. 7 is a front, fragmentary view of the step assembly of FIG. 1 in the floor cabinet; and

FIG. 8 is perspective front view of the front face of another embodiment of a step assembly according to the present invention.

### DETAILED DESCRIPTION OF THE INVENTION

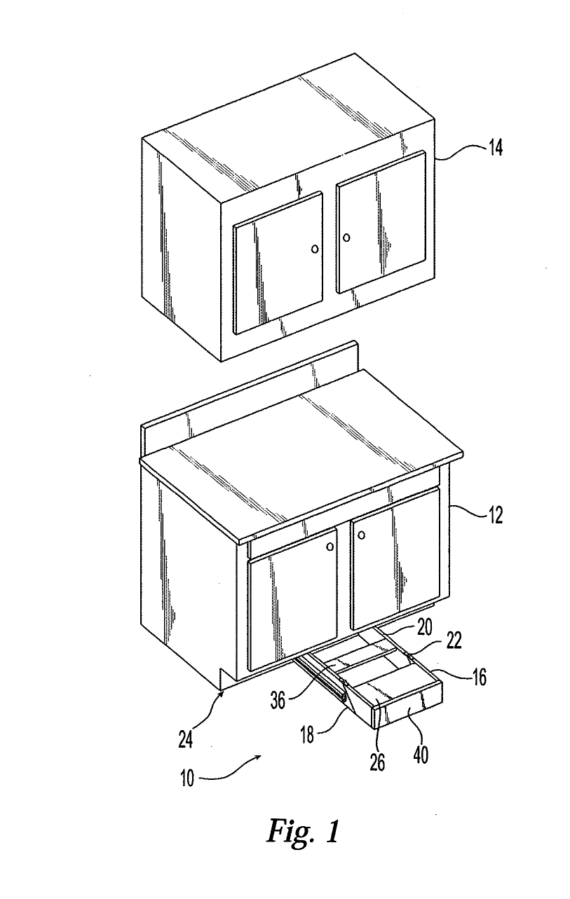

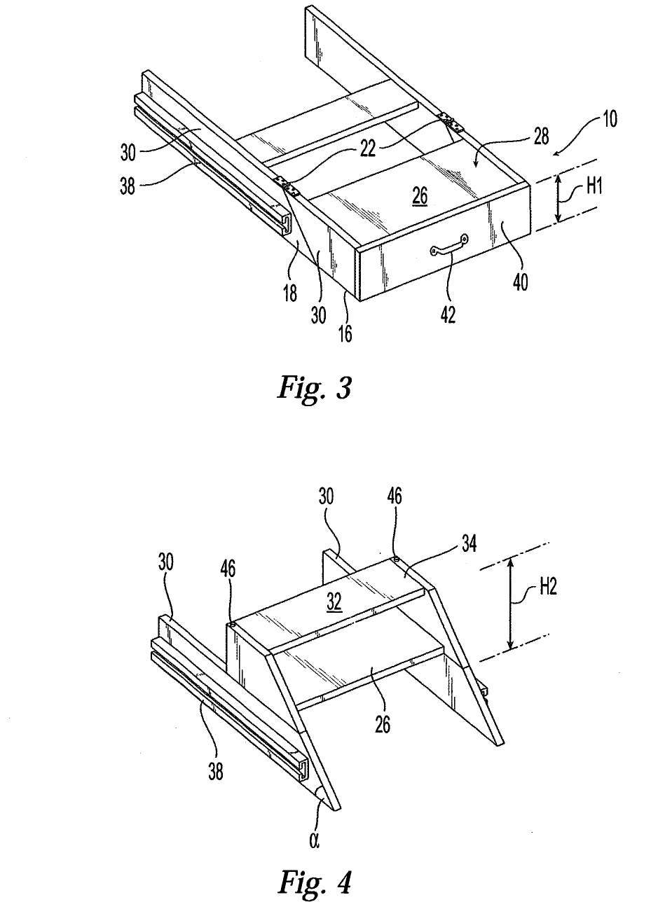

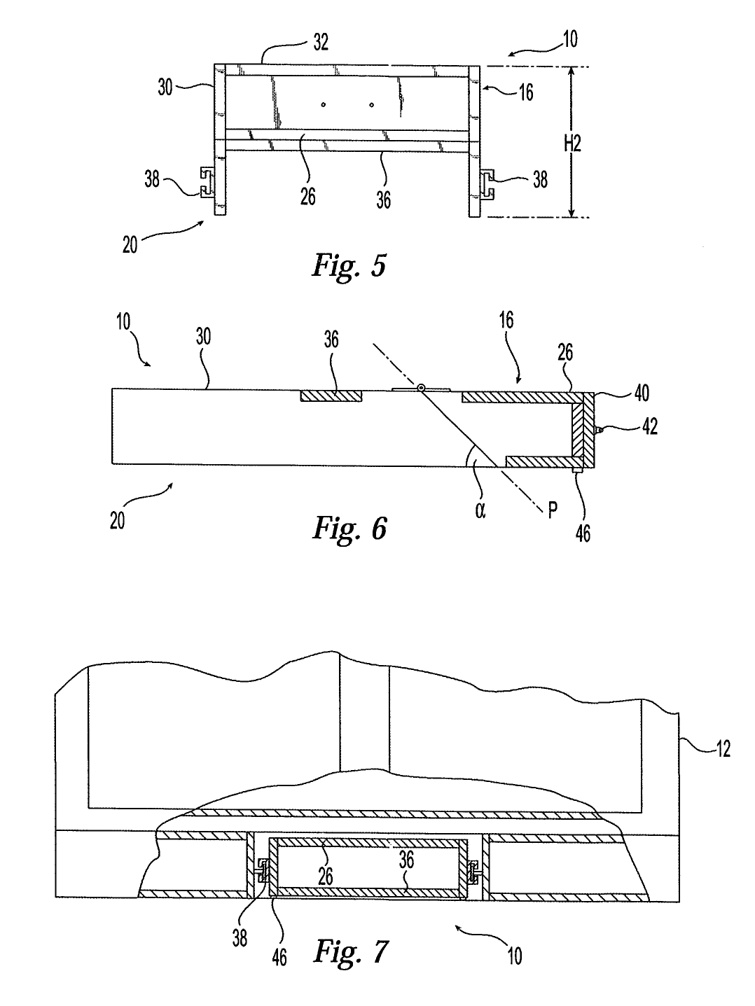

A step assembly 10 according to the present invention is illustrated in FIG. 1 in use with a floor cabinet 12 and upper cabinet 14. The cabinets 12,14 could be of any configuration and type mounted in any location, including the kitchen, bathroom, storage/laundry room, or even the garage. As best seen in FIGS. 3 and 4, the step assembly 10 has a step 16 connected to a first end 18 of a base 20 by hinges 22. The step assembly 10 is typically stored under the floor cabinet 12 in kick space 24. The step assembly 10 is shown in FIGS. 1 & 3 in a first configuration. The step 16 has a first stepping surface 26 on a first side 28. The first stepping surface 26 is positioned for use when the step assembly 10 is in the first configuration. The step assembly 10 has a first height H1 that generally corresponds to the height of the kick space 24 (typically about 4 inches), but the height H1 could also be less than the height of the kick space 24 is so desired. The step assembly 10 is shown to have a width that is about the width of one side of the floor cabinet 12. However, the width of the step assembly 10 could be smaller or larger than shown, depending on a user's needs or desires. Similarly, while the step assembly 10 is shown in the middle of floor cabinet 12, it could be positioned anywhere in the floor cabinet the user would like it.

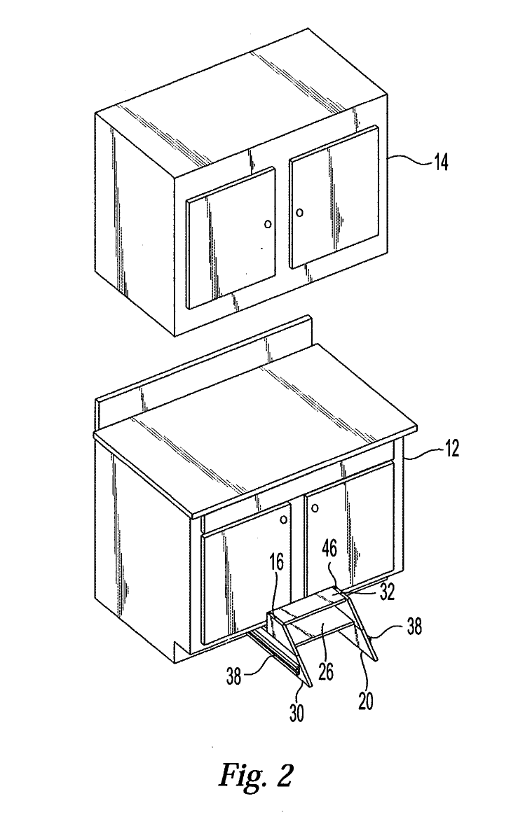

The step assembly 10 is shown in a second configuration in FIGS. 2 and 4. The step 16 is rotated about the hinges 22 to rest on top of the base 20. The step 16 and base 20 are separated from one other along a plane P (see FIG. 6) that forms an angle α that is about 45° relative to the floor. The angle a may be greater or smaller, depending on a user's preference. With the angle α at about 45°, the side rails 30 are typically out of the way of the user if the user must step off or on to the step assembly 10 from either side. Also, the side rails 30 also present less of a tripping hazard to the user and others when the step assembly 10 is being used.

In the second configuration, the step assembly 10 has a second stepping surface 32 on a second side 34 for the user to step on. The second stepping surface 32 is hidden from view and use when the step assembly 10 is in the first configuration. However, the second stepping surface 32 does assist in this configuration by providing rigidity to the step assembly 10. In the second configuration, the step assembly 10 has height H2, which is about twice the height of the base 20 (height of H1, which is about 4 inches). While the height of the base 20 and the step 16 are illustrated to be the same, they may be of different heights, with either one being higher than the other. Obviously, they should be not larger than the kick space 24.

Two hinges 22 are shown, one on each of the side rails 30. However, a single piano hinge may also be used to provide more stability and ruggedness if so desired. The support bar 36 may be moved forward to the plane P, where the step 16 and the base 20 are connected, to provide a surface for attaching the piano hinge. Similarly, the first stepping surface 26 may be extended backwards to allow the piano hinge to be mounted thereon.

The step assembly 10 is preferably mounted in the kick space 24 below the storable space in the floor cabinet 12. The step assembly 10 is preferably mounted in the floor cabinet 12 by drawer rails 38, which allows the step assembly to be withdrawn from the floor cabinet 12 by a predetermined amount. Similarly, the step assembly 10 will only travel the predetermined distance so that the front face 40 of the step assembly is flush with the cabinet in the kick space 24. While drawer rails 38 are shown, the step assembly 10 could be mounted to the cabinet with any appropriate mechanism, including for example, a tongue and groove system, or the step assembly 10 could be mounted on wheels to engage and roll along the floor to allow the step assembly to be rolled out from under the floor cabinet 12.

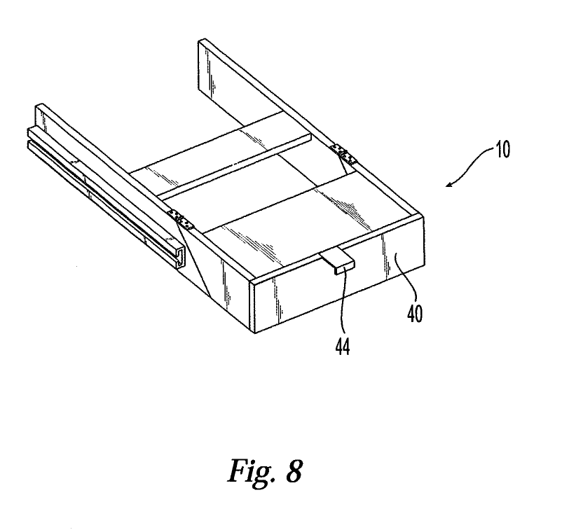

Also, while a handle 42 that extends outward from the front face of the step assembly 10 is illustrated in the figures, the handle could be integral with the drawer, not extending beyond the front face, thereby not being a tripping hazard or drawing attention to the step assembly. Additionally, a tab 44 could replace the handle 42, as shown in FIG. 8. The tab 44 could be mounted on the top of the front face 40 as shown, or along one side of the front face 40. If the tab 44 were mounted on a side edge of the front face, it would accessible to the user's foot, and the user could use their foot to pull the step assembly 10 out from the floor cabinet 12 and to rotate the step 16 around the hinges 22 and into the second configuration. Similarly, the user could use their foot and tab 44 to move the step 16 from the second configuration back to the first configuration without having to bend over.

The step assembly 10 also has skid elements 46 mounted to the second stepping surface or the side rails 30 on the step 16. Preferably the skid elements 46 assist in keeping the step 16 in the same plane as the base 20. While the step 16 is held in position by the hinges 22 and by the engagement of the step 16 with the base 20 along the plane P, the skid elements 46 keep the step 16 from engaging the floor directly in front of the step assembly 10 and from also putting undue stress on the drawer rails 38 or other engagement elements 38 when the step assembly 10 is pulled out from the floor cabinet 12.

It should also be noted that the step assembly 10 can be attached to the cabinet during its manufacture or even mounted in the floor cabinet after the floor cabinet has been installed.

It will be apparent to those skilled in the art that various modifications and variations can be made in the step assembly of the present invention without departing from the spirit or scope of the invention. Thus, it is intended that the present invention cover the modifications and variations of this invention provided they come within the scope of the appended claims and their equivalents.

1. A retractable and extensible step assembly to be disposed within a kick space in a cabinet on the floor, the step assembly comprising:
a base;
a step hingingly connected to a first end of the base, the step having a first stepping surface and a second stepping surface, the first stepping surface being disposed on a first side of the step and the second stepping surface being disposed on a second side of the step, the first and second sides being opposite one another; and
a cabinet engagement means disposed on the base to slidingly engage the cabinet.

2. The retractable and extensible step assembly of claim 1, wherein the cabinet engagement means is a drawer slide.

3. The retractable and extensible step assembly of claim 1, further comprising at least one hinge to hingingly connect the step to the base.

4. The retractable and extensible step assembly of claim 3, wherein the step pivots about the at least one hinge to rest upon The base.

5. The retractable and extensible step assembly of claim 1, the retractable and extensible step having a first and a second configuration, the step and the base lie within a single plane in the first configuration and the step is disposed on top of the base in a second parallel plane in the second configuration.

6. The retractable and extensible step assembly of claim 5, wherein the step has a first height in the first configuration and a second height in the second configuration, the second height being about twice the first height.

7. The retractable and extensible step assembly of claim 1, wherein the step is joined to the base along a predetermined plane, wherein the predetermined plane is angled backward away from the first end of the base at a predetermined angle.

8. The retractable and extensible step assembly of claim 7, wherein the predetermined angle is about 45°.

9. The retractable and extensible step assembly of claim 1, wherein the step has a front surface, the front surface having a handle to allow the retractable and extensible step to be pulled into a usable location by a user.

10. The retractable and extensible step assembly of claim 9, wherein the front surface matches the cabinet into which it is installed.

11. The retractable and extensible step assembly of claim 1, wherein the handle is a tab mounted on one edge of the front face.

12. A retractable and extensible step assembly to be added to a kick space within a cabinet after the cabinet has been installed at a location, the step assembly comprising:
a sliding element to attach the step assembly to the kick space within the cabinet;
a retractable and extensible step assembly, the step assembly comprising:
a base;
a step hingingly connected to the base, the step having a first stepping surface and a second stepping surface, the first stepping surface being disposed on a first side of the step and the second stepping surface being disposed on a second side of the first step, the first and second sides being opposite one another.

13. The retractable and extensible step assembly of claim 11, further comprising a front surface configured to match the cabinet into which the step assembly is to be installed.

14. A retractable and extensible step assembly to be disposed within a cabinet on the floor, the step assembly comprising:
a base configured to have a least a portion thereof to be disposed within the cabinet when the step is fully extended;
a step hingingly connected to a first end of the base, the step having a first stepping surface and a second stepping surface, the first stepping surface being disposed on a first side of the step and the second stepping surface being disposed on a second side of the step, the first and second sides being opposite one another; and
a cabinet engagement element disposed on the base to slidingly engage the cabinet.
